(19) United States
(12) Patent Application Publication
(10) Pub. No.: US 2007/0046656 A1
(43) Pub. Date: Mar. 1, 2007

(54) DISPLAY APPARATUS, DISPLAY METHOD, AND STORAGE MEDIUM STORING DISPLAY PROGRAM

(75) Inventors: Yumiko Nakamura, Kawasaki (JP); Haruyo Iguchi, Kawasaki (JP); Kouichi Kawata, Kawasaki (JP); Hiroyuki Maekawa, Kawasaki (JP); Akiko Maruyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/275,941

(22) Filed: Feb. 6, 2006

(30) Foreign Application Priority Data
Aug. 24, 2005 (JP) 2005-243452

(51) Int. Cl. G09G 5/00

(52) U.S. Cl. 345/204

(57) ABSTRACT

The display apparatus of the present invention performs display processing for outputting and displaying a plurality of screens consecutively on a display unit. The apparatus comprises a restart screen determination unit for obtaining a restart screen based on the screen displayed on the display unit when canceled, and a screen output unit for outputting the obtained screen on the display unit.

### BACKGROUND OF THE INVENTION

1. Field of the Invention

The present invention relates to a display apparatus, a display method and storage medium storing a display program.

2. Description of the Related Art

There are programs for outputting a plurality of screens consecutively on a display unit (i.e. a display). In this program, each screen is presented to users in accordance with a predetermined screen transition order. There are several types of screen presented to the users such as a screen for providing reading text on the screen to users, a screen for making a selection by a radio button etc. and a screen for inputting a variety of information in an input field. Such a program in general, when canceled by a user, resumes from the point of cancellation.

Patent Document 1, for example, discloses a technology for, when an operation lesson is canceled, resuming from where it is canceled.

However, in a case of an operating instruction screen etc., even if resumed from the canceled point, the instruction starts from the middle, which sometimes renders it difficult for users comprehend what is presented.

Patent Document 1: Japanese Laid-Open Patent Application Publication No. 2000-227816 “Operating Lesson Apparatus and Program Storage Medium thereof”

### SUMMARY OF THE INVENTION

It is an object of the present invention to provide a display apparatus, display method and storage medium for storing a display program, which enables a user to restart from a screen, which can be easily comprehended by the user.

The display apparatus of the present invention is a display apparatus for performing processing of outputting and displaying a plurality of screens consecutively on the display unit, comprising a restart screen determination unit for obtaining a restart screen based on the screen displayed on the display unit when canceled, and a screen output unit for outputting the obtained screen on the display unit.

Here, a restart screen corresponding to a canceled screen can be obtained by the restart screen determination unit employing a storage unit with a correspondence between the canceled screen and the restart screen. Therefore, it is possible for a user to restart from a screen, which can be easily comprehended by the user, by assigning an appropriate screen close to the canceled screen as a restart screen.

According to the present invention, employing a storage unit with a correspondence between a canceled screen and a restart screen, a restart screen corresponding to a canceled screen can be obtained, and therefore, by assigning an appropriate screen close to the canceled screen, for example the beginning of a chapter, as a restart screen, it is possible for a user to restart from a screen, which is easily comprehended by the user.

### BRIEF DESCRIPTION OF THE DRAWINGS

FIG. 1 is a block diagram (No. 1) describing a configuration of the display apparatus of the first embodiment of the present invention;

FIG. 2 is a diagram showing an example of the canceled screen/restart screen correspondence table of FIG. 1;

FIG. 3A is a diagram showing a display example (No. 1) of a screen in the correspondence table of FIG. 2;

FIG. 3B is a diagram showing a display example (No. 2) of a screen in the correspondence table of FIG. 2;

FIG. 3C is a diagram showing a display example (No. 3) of a screen in the correspondence table of FIG. 2;

FIG. 3D is a diagram showing a display example (No. 4) of a screen in the correspondence table of FIG. 2;

FIG. 4 is a diagram (No. 1) explaining positions of the canceled screen and the restart screen;

FIG. 5 is a diagram (No. 2) explaining positions of the canceled screen and the restart screen;

FIG. 6 is a flowchart of processing in activation (including a case of restart) of the display apparatus of the first embodiment;

FIG. 7 is a block diagram (No. 2) describing a configuration of the display apparatus of the first embodiment of the present invention;

FIG. 8 is a flowchart of processing in clicking the “Next” button of the display apparatus of the first embodiment;

FIG. 9 is a block diagram describing a configuration of the display apparatus of the second embodiment of the present invention;

FIG. 10 is an example of the select screen output on the display unit by the restart screen select screen output unit of FIG. 9;

FIG. 11 is a flowchart of processing in activation (including a case of restart) of the display apparatus of the second embodiment;

FIG. 12 is a block diagram describing a configuration of a variation (No. 1) of the display apparatus of the second embodiment of the present invention;

FIG. 13 is an example of select screen output on the display unit by the restart screen select screen output unit of FIG. 12;

FIG. 14 is a variation of the canceled screen/restart screen correspondence table of FIG. 2;

FIG. 15 is a flowchart of processing in activation (including a case of restart) of the variation (No. 1) of the display apparatus of the second embodiment;

FIG. 16 is a block diagram describing a configuration of a variation (No. 2) of the display apparatus of the second embodiment of the present invention;

FIG. 17 is an example of the select screen output on the display unit by the restart screen select screen output unit of FIG. 16;

FIG. 18 is a flowchart of processing in activation (including a case of restart) of the variation (No. 2) of the display apparatus of the second embodiment;

FIG. 19 is a block diagram describing a configuration of the display apparatus of the third embodiment of the present invention;

FIG. 20 is a diagram showing an example of the screen type table of FIG. 19;

FIG. 21 is a flowchart of processing in activation (including a case of restart) of the display apparatus of the third embodiment; and

FIG. 22 is a diagram describing an example of storage medium.

### DESCRIPTION OF THE PREFERRED EMBODIMENT

In the following description, details of the preferred embodiments of the present invention are explained with reference to the drawings.

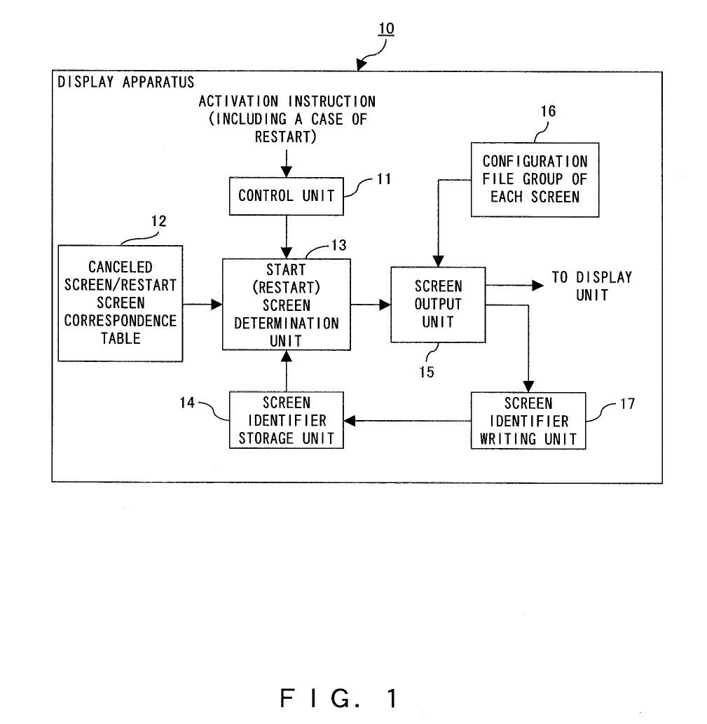

FIG. 1 is a block diagram (No. 1) describing a configuration of the display apparatus of the first embodiment of the present invention. FIG. 1 describes a functional block, when an activation instruction is accepted by a control unit 11, and which is activated in association with the acceptance.

As shown in FIG. 1, a display apparatus 10 comprises a control unit 11 for controlling each unit, a screen identifier storage unit 14, which is able to store an ID (identifier) of a screen displayed when canceled on a display unit (not shown in FIG. 1), a canceled screen/restart screen correspondence table 12 for maintaining a correspondence between a canceled screen ID and a restart screen ID, a start (restart) screen determination unit 13 for obtaining a restart screen ID corresponding to an obtained screen ID, employing the table 12 with a correspondence between the canceled screen and the restart screen as well as obtaining an identifier of a screen stored in the screen identifier storage unit 14, a screen output unit 15 for selecting a configuration file corresponding to the obtained screen ID from a configuration file group 16, for generating a screen based on the selected configuration file, and for outputting it to the display unit, and a screen identifier writing unit 17 for overwriting the ID of the output screen in the screen identifier storage unit 14.

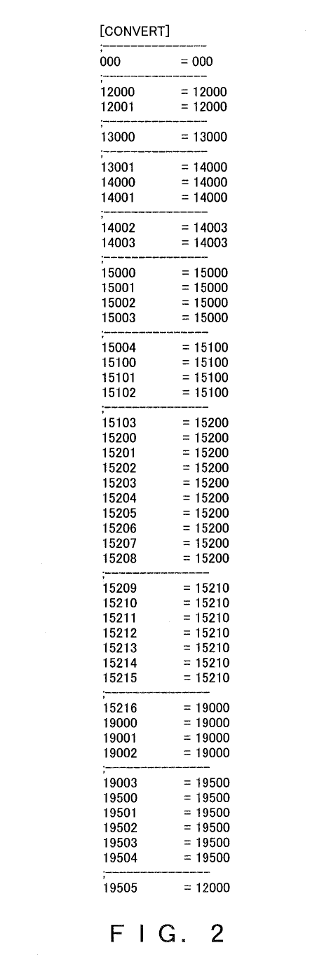

FIG. 2 is a diagram showing an example of the canceled screen/restart screen correspondence table of FIG. 1.

As shown in FIG. 2, the canceled screen/restart screen correspondence table is a table, which maintains the correspondence between the ID of a canceled screen (left) and the ID of a restart screen (right).

In an example of FIG. 2, IDs of the canceled screen are serialized and displayed in such a way that the numbers are displayed in ascending order. In FIG. 2, the screen of the screen ID=000 indicates a screen of an invoker of the program. On starting the program the first screen to be displayed is a screen of a screen ID=12000. The correspondence is such that, in a case of cancellation at the last screen of the screen transition order (screen ID=19505), the program is set to restart from the first screen of the program (screen ID=12000).

The present embodiment concerns a configuration program of a personal computer. In the correspondence table in FIG. 2, the numbers in the 12000s, 13000s, 14000s, 15000s, and 19000s correspond to each chapter of the configuration program. A chapter in the 15000s is divided into sections of 15000-15004, 15100s, and 15200s, which are for example a browser setting, a printer setting etc.

For the screen IDs (such as the screen ID=13001, 15004, 15103, and 15216), which are the final pages of each chapter, the corresponding restart screen is the first screen of the next chapter (the screen ID=14000, 15100, 15200, and 19000 respectively), because the last page often has a description of a comment such as “the end of this chapter”.

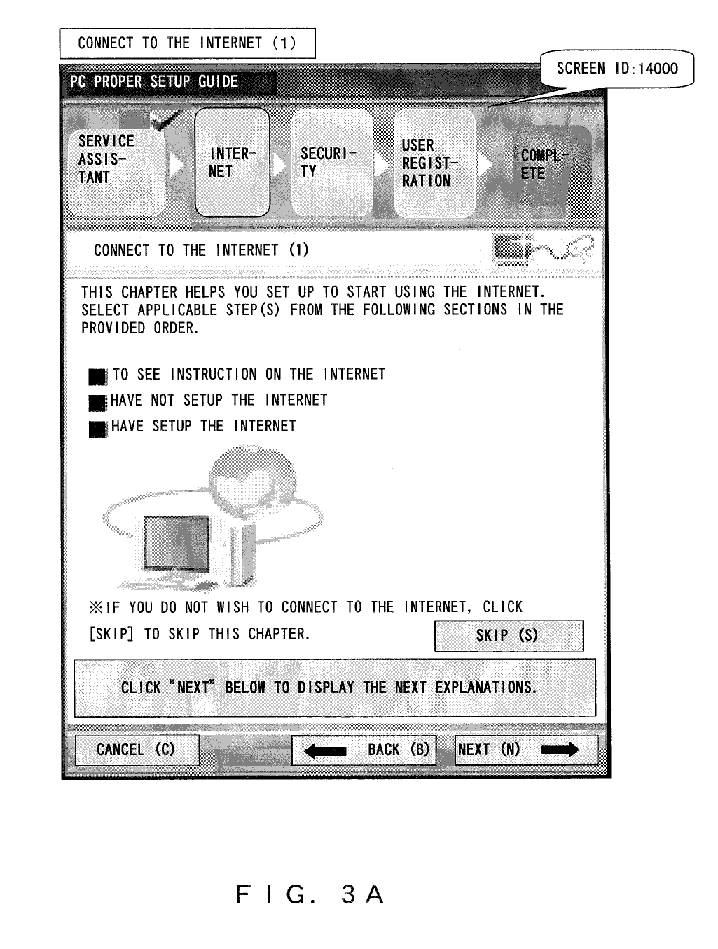

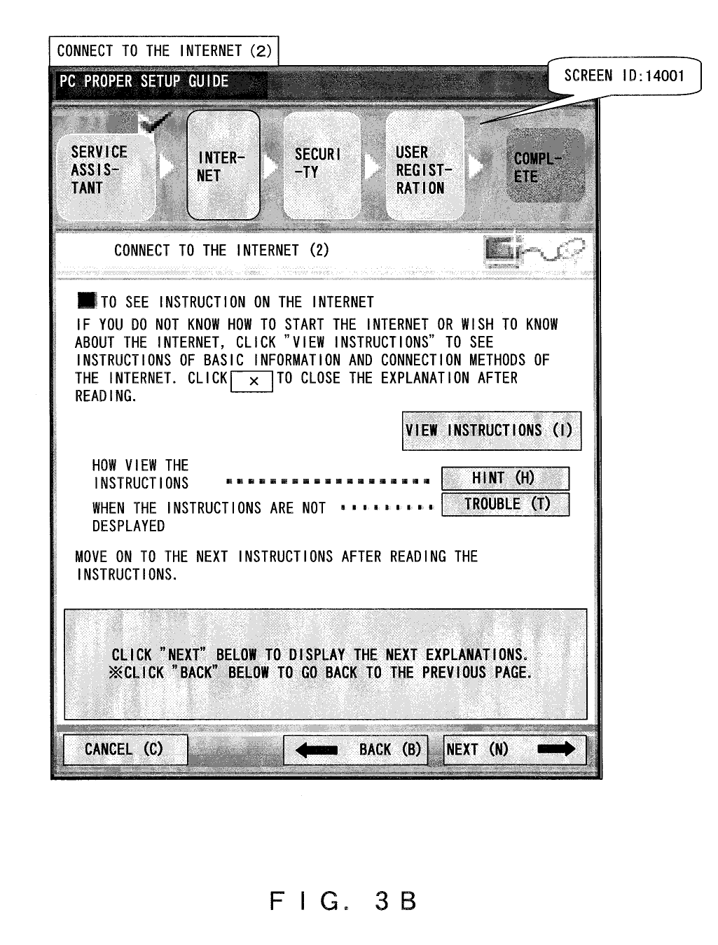

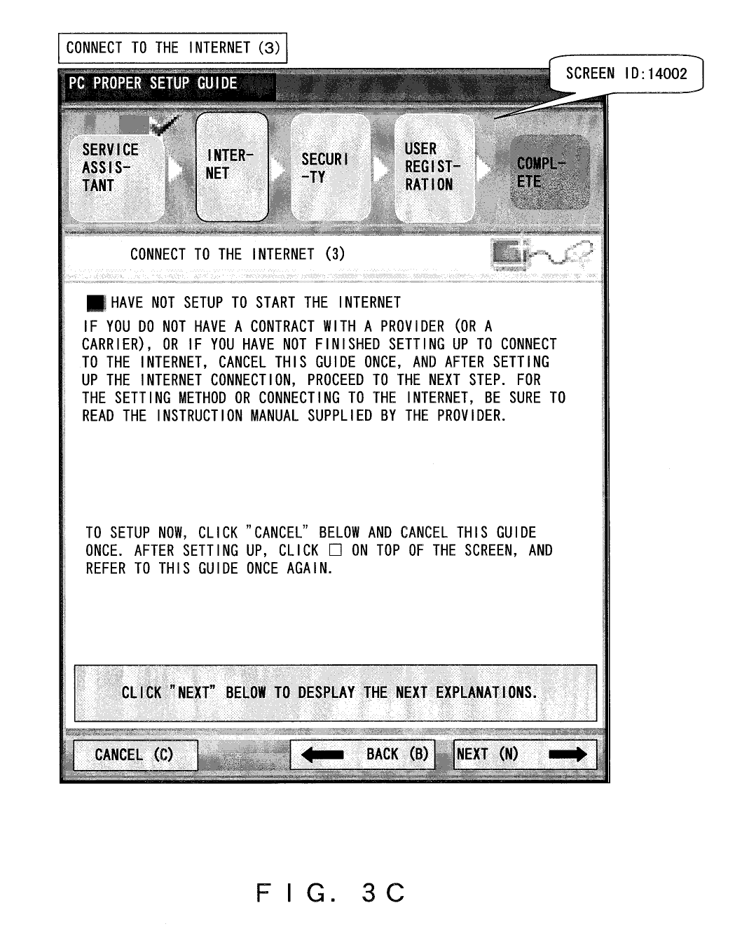

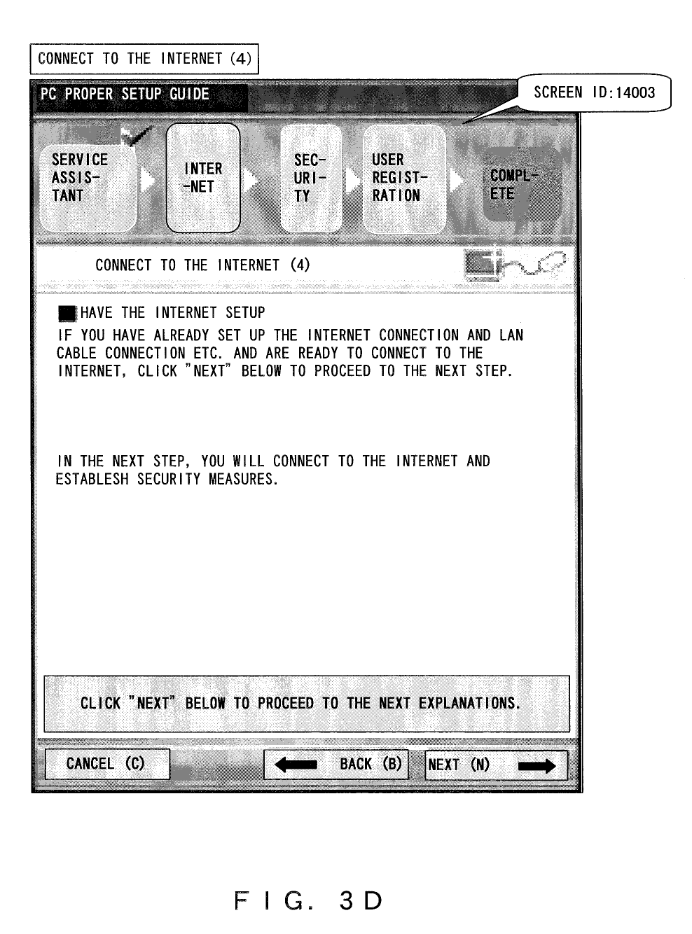

FIG. 3A-FIG. 3D are diagrams showing display examples of some of the screens in the correspondence table of FIG. 2. In other words, FIG. 3A is an example screen of the screen ID=14000, FIG. 3B is of the screen ID=14001, FIG. 3C is the screen ID=14002, and FIG. 3D is of the screen ID=14003.

Individual screens shown in FIG. 3A-FIG. 3D have a “cancel” button provided to the lower left, and by a user clicking the button, the program processing can be canceled.

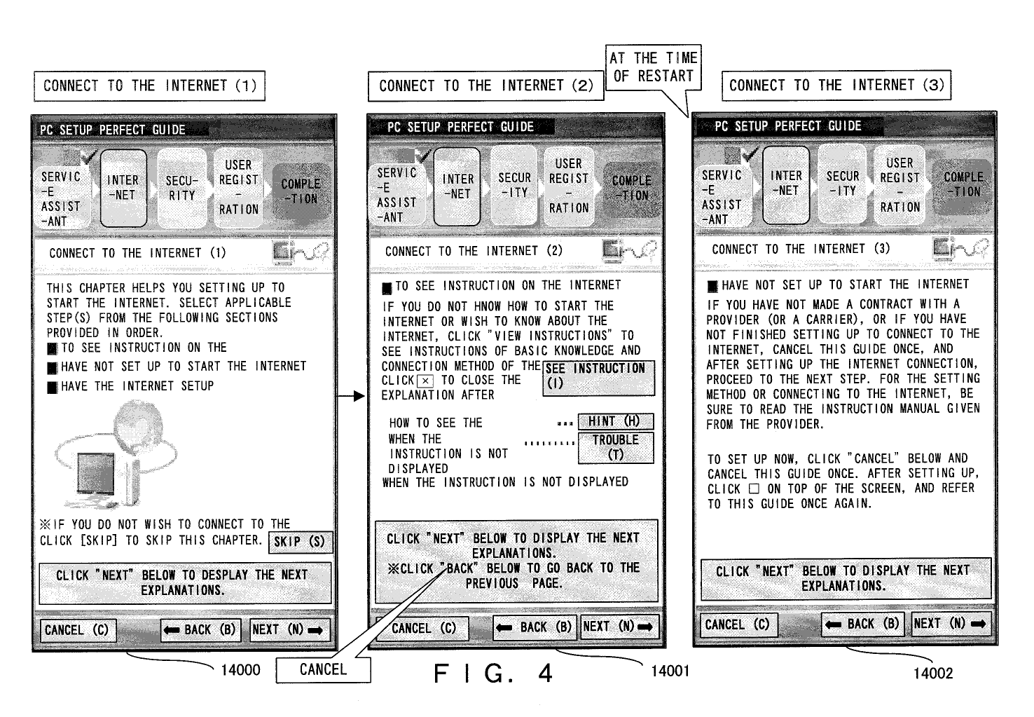

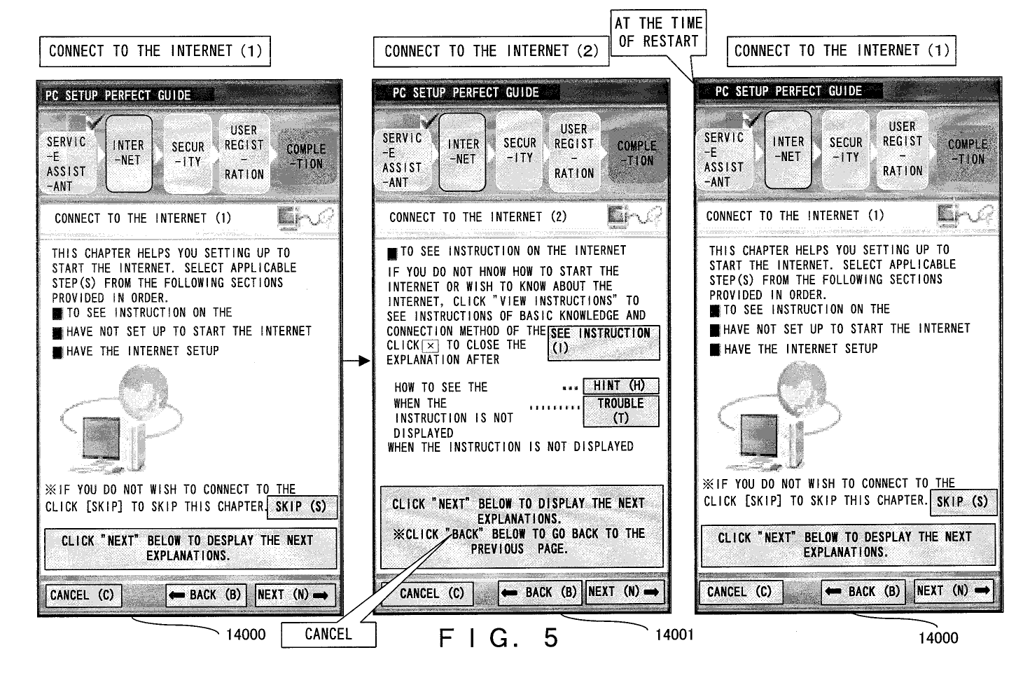

For example, when the “cancel” button is clicked in the screen of the screen ID=14001, the screen of the screen ID=14002 might be an appropriate point for the restart screen (easily comprehended by the user) as shown in FIG. 4 or the screen of the screen ID=14000, the screen previous to the screen of the screen ID=14001, might be an appropriate point for the restart screen as shown in FIG. 5.

As explained above, in the present embodiment, the canceled screen/restart screen correspondence table is set so that a screen, which is an appropriate point close to the canceled screen, can be the restarting point. By so doing, it is possible to restart the program from a point (a screen or a page), which can be easily comprehended by the user at restart.

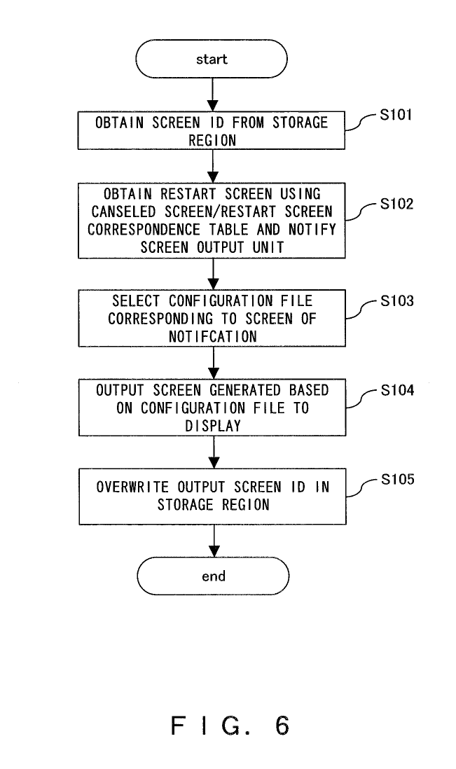

Next, an operation of the display apparatus 10 of FIG. 1 is explained with reference to a flowchart of FIG. 6.

First, a program is started by a user. The program comprises processing for outputting a plurality of screens consecutively on a display unit (i.e. a display). A control unit 11 in FIG. 1, when accepting an activation instruction, activates a start (restart) screen determination unit 13. In step S101 of FIG. 2, a screen identifier (a.k.a. a screen ID or a page ID) to be stored in the screen identifier storage unit (storage region) 14 is obtained by the start (restart) screen determination unit 13. In the screen identifier storage unit 14, when activated at restart, the screen ID displayed in the display unit at the time of the cancel is stored.

In the following step S102, the start (restart) screen determination unit 13 refers to the canceled screen/restart screen correspondence table 12, obtains the restart screen ID corresponding to the ID of the canceled screen obtained in step S101, and notifies a screen output unit 15 of the ID.

In step S103, a configuration file of the screen ID of the above notification from the configuration file group (screen ID, INI file) of each screen is selected by the screen output unit 15.

In step S104, based on the configuration file of a screen selected in step S103, the screen is generated by the screen output unit 15 and is output to the display unit (i.e. the display).

In step S105, a screen identifier writing unit 17 is activated by the screen output unit 15, and the ID of the screen output to the display unit is overwritten in the screen identifier storage unit 14 by the screen identifier writing unit 17.

When a program activation by the user is not an activation on restart, the value in the screen identifier storage unit 14 is initialized. In such a case, the start (restart) screen determination unit 13 notifies the screen output unit 15 of the screen ID of the first screen of the activated program, and by the screen output unit 15, the first screen of the program is output on the display unit.

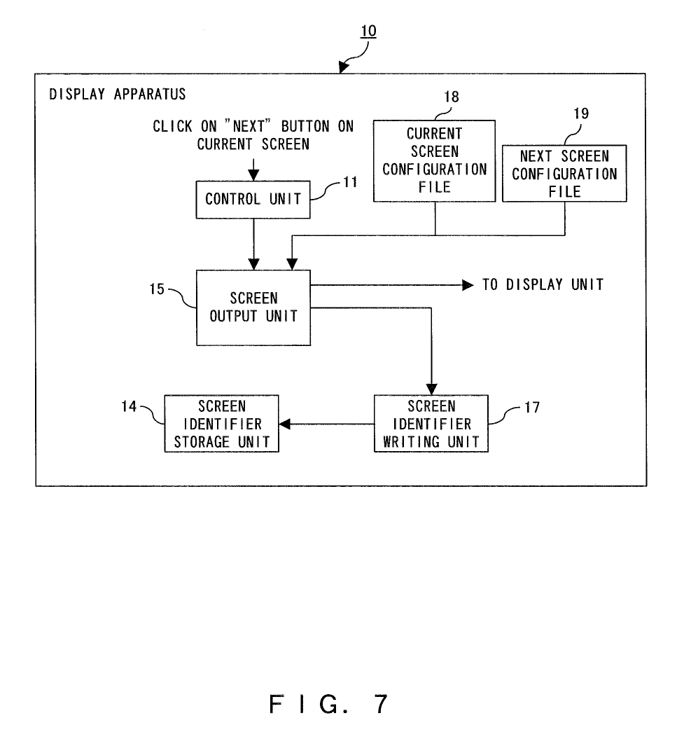

FIG. 7 is a block diagram (No. 2) describing a configuration of the display apparatus of the first embodiment of the present invention.

FIG. 7 shows a functional block to be activated in association with the control unit 11 accepting information indicating the click of a “Next” button on the currently displayed screen, for example.

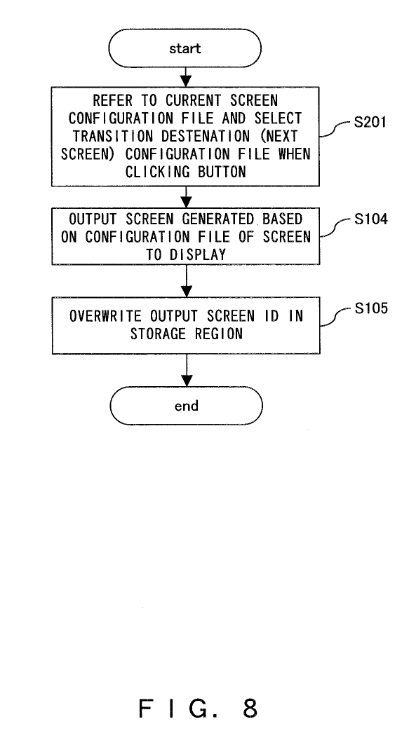

An operation of the display apparatus 10 of FIG. 7 is explained with reference to a flowchart of FIG. 8.

When the control unit 11 accepts information indicating the click of the “Next” button on the current screen, the control unit 11 activates the screen output unit 15. In step S201 of FIG. 8, the screen output unit 15 refers to a configuration file 18 of the current screen. In other words, when the “Next” button is clicked, the information of a transition destination screen (the next screen), in the configuration file 18 of the current screen, is referred to, and a configuration file 19 of the next screen is selected. Afterwards, steps S104 and S105 in FIG. 6 are executed.

That is, in step S104, the next screen is generated by the screen output unit 15 using the selected configuration file 19 (of the next screen), and is output to the display unit. In step S105, the screen identifier writing unit 17 is activated by the screen output unit 15, and the ID of the restart screen output to the display unit is overwritten on the screen identifier storage unit 14 by the screen identifier writing unit 17.

The functional block when the “Next” button in the current screen is clicked (FIG. 7) and the flowchart (FIG. 8), are in common in each embodiment.

There are some programs that invoke other programs from the screen. For example, in the case of a configuration program, there is occasion when a program for updating to the latest version of an OS or a program for virus check may be invoked from the configuration program. At that time, there is sometimes a case where processing is canceled by the program performing the update. In such a case, the cancel is performed without clicking the “cancel” button on the screen of the invoker.

As shown in the flow of FIG. 8, by overwriting the ID of the screen output to the storage region for every output of the screen to the display unit, even in a case of cancellation by programs invoked by the invoking program, the screen displayed on the display unit at the time of cancellation can be stored in the storage region. However, some programs do not invoke programs. In that case, instead of step S105 being performed in each flow, the ID in the display screen is overwritten in the storage region, triggered by the click of the “cancel” button on the display screen.

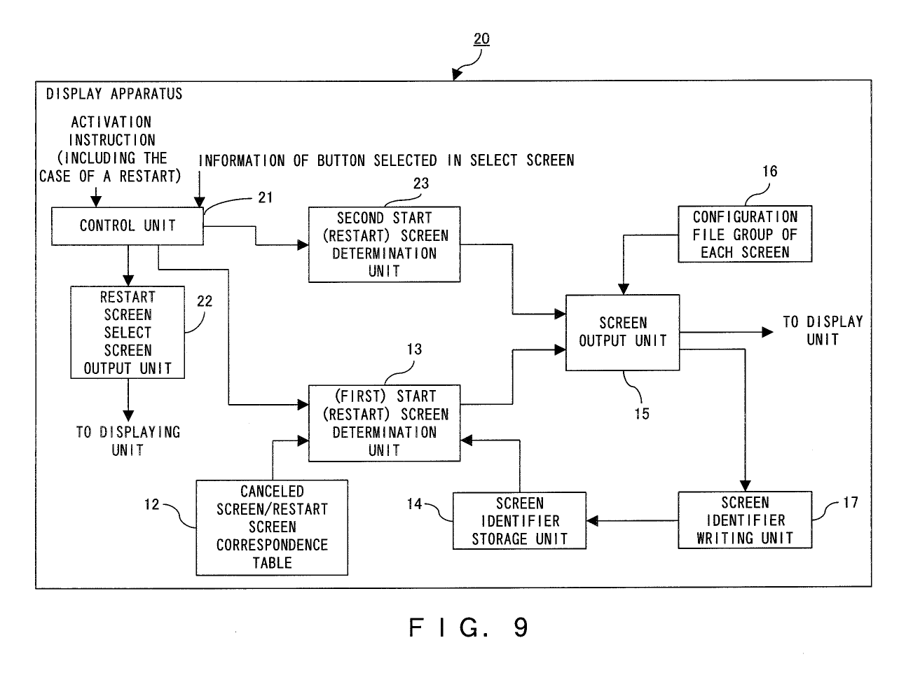

FIG. 9 is a block diagram describing a configuration of the display apparatus of the second embodiment of the present invention. FIG. 9 shows a functional block activated in association with each of a case that a control unit 21 accepts an activation instruction, and a case that the control unit 21 accepts information of a button selected in the select screen displayed on restart.

A display apparatus 20 shown in FIG. 9, compared with the display apparatus 10 of FIG. 1, further comprises a second start (restart) screen determination unit 23 for obtaining the first screen ID as the restart screen ID and for notifying the screen output unit 15 of the ID, and a restart screen select screen output unit 22 for outputting the screen for selecting the restart screen to the display unit.

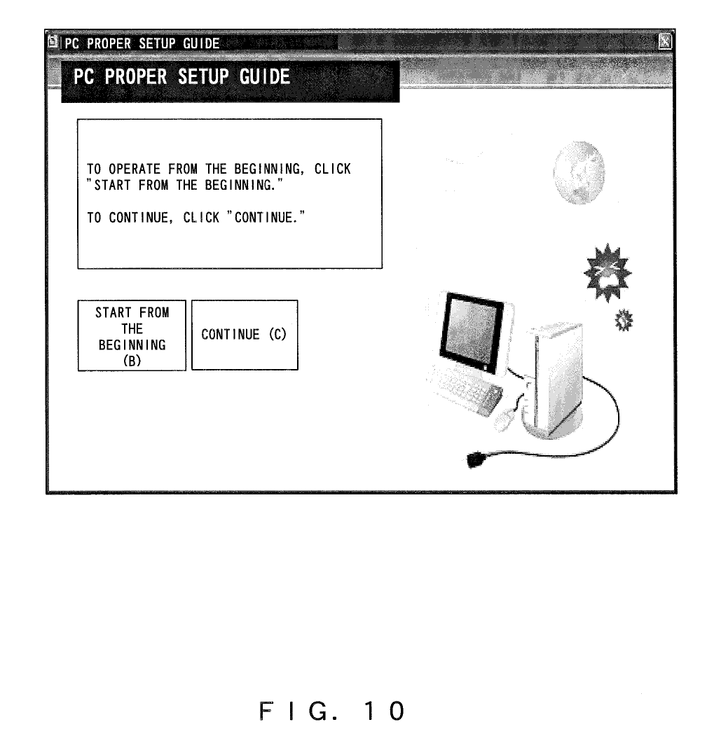

FIG. 10 is an example of the select screen output on the display unit by the restart screen select screen output unit of FIG. 9.

As shown in FIG. 10, a “Start from the beginning” button, and “Continue” button are provided on the select screen.

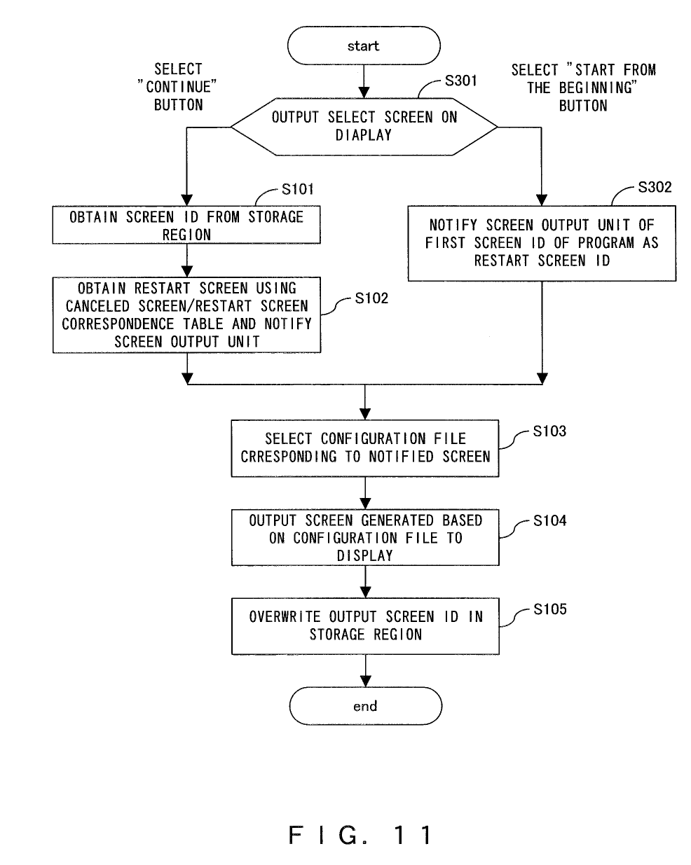

An operation of the display apparatus 20 of FIG. 9 is explained with reference to a flowchart of FIG. 11.

First, a program is activated by a user. The program is for outputting a plurality of screens consecutively on a display unit (i.e. a display). The control unit 21 of FIG. 9, upon accepting the activation instruction, activates the restart screen select screen output unit 22. In step S301 of FIG. 11, the select screen is output and displayed on the display unit based on the configuration file of the select screen by the restart screen select screen output unit 22. When the “Continue” button on the select screen is clicked by a user, the processing of steps S101-S105 of FIG. 6 is performed by the (first) start (restart) screen determination unit 13 etc.

When the “Start from the beginning” button on the select screen is clicked by the user, in step S302, by the second start (restart) screen determination unit 23, the screen ID of the first screen of the program is obtained as a restart screen ID, and the screen output unit 15 is notified of the ID. Afterwards, the processing of steps S103, S104 and S105 of FIG. 6 is performed.

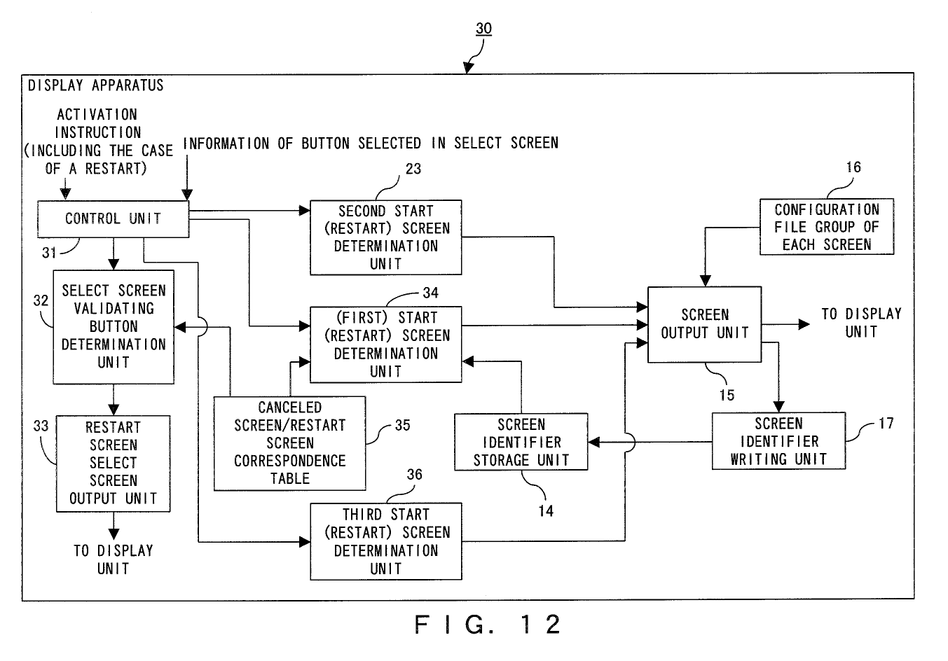

FIG. 12 is a block diagram describing a configuration of a variation (No. 1) of the display apparatus of the second embodiment of the present invention. FIG. 12 shows a functional block activated in association with each of a case that a control unit 31 accepts an activation instruction, and a case that the control unit 31 accepts information of a button selected in the select screen displayed on restart.

A display apparatus 30 shown in FIG. 12 comprises a control unit 31 for controlling each unit, a screen identifier storage unit 14, which is able to store the ID (identifier) of the screen last displayed on the display unit (not shown in the drawing), a canceled screen/restart screen correspondence table 35 of the correspondence between the canceled screen ID and the restart screen ID, a second start (restart) screen determination unit 23 for obtaining the first screen ID as the restart screen ID and for notifying the screen output unit 15 of the ID, a (first) start (restart) screen determination unit 34 for obtaining a screen identifier stored in the screen identifier storage unit 14 and the restart screen ID corresponding to the obtained screen ID employing the table with a correspondence between a canceled screen and a restart screen, and for notifying the screen output unit 15 of the obtained screen ID, a third start (restart) screen determination unit 36 for obtaining a screen identifier stored in the screen identifier storage unit 14 and for notifying the screen output unit 15 of the ID, a screen output unit 15 for selecting a configuration file corresponding to the notified screen ID from the configuration file group 16, for generating a screen based on the selected configuration file, and for outputting to the display unit, a screen identifier writing unit 17 for overwriting the output screen ID on the screen identifier storage unit 14, a restart screen select screen output unit 33 for outputting a screen for selecting the restart screen, and a select screen validating button determination unit 32 for determination of a button to validate the select screen.

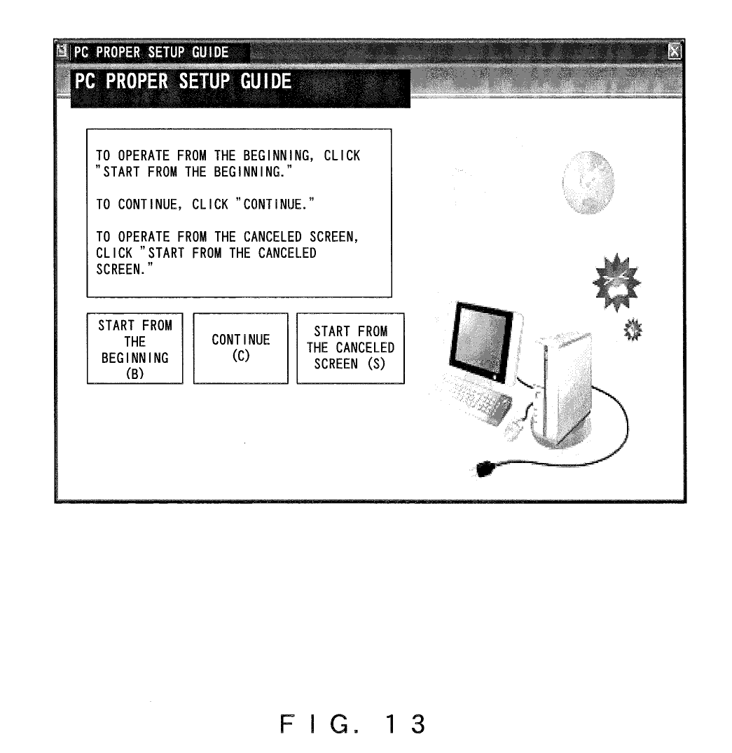

FIG. 13 is an example of select screen output on the display unit by the restart screen select screen output unit of FIG. 12.

As shown in FIG. 13, on the select screen, a “Start from the canceled screen” button is provided as another option in addition to the “Start from the beginning” button and the “Continue” button. Whether to validate the “Start from the canceled screen” button on the select screen or not is determined by the select screen validating button determination unit 32.

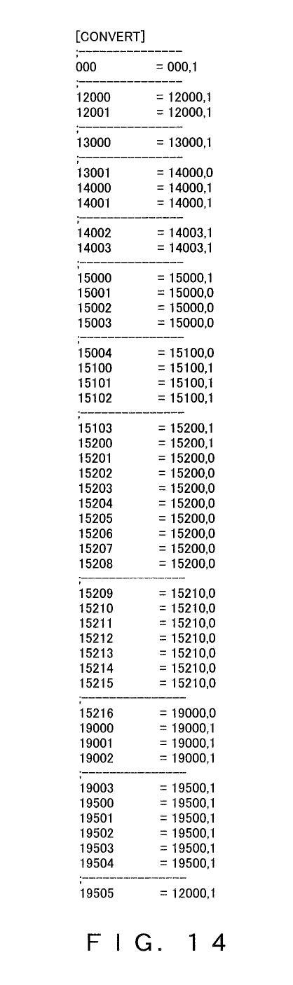

For example, the select screen validating button determination unit 32 may validate the “Start from the canceled screen” button when the restart screen, which is a result of the processing triggered by the click of the “Continue” button, does not correspond to the canceled screen. Alternatively, as shown in FIG. 14, by adding flag information (“0” or “1”) to the end of the restart screen ID of the canceled screen/restart screen correspondence table 35, and by referring to the flag information, it may be determined whether to validate the “Start from the canceled screen” button or not.

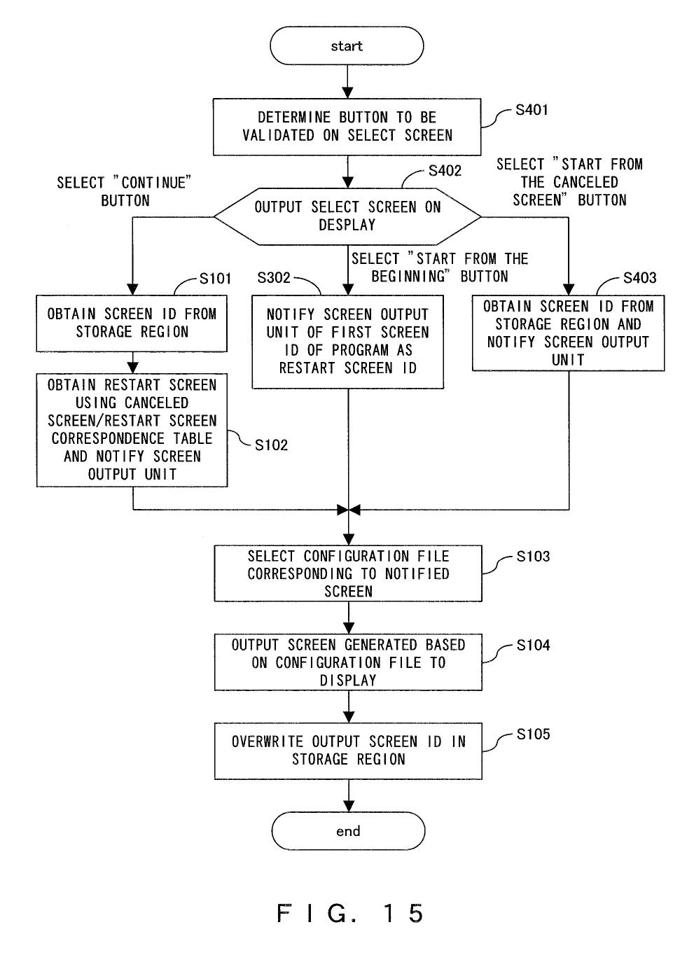

An operation of the display apparatus 30 of FIG. 12 is explained with reference to the flowchart of FIG. 15.

First, a program is activated by a user. The program is for outputting a plurality of screens consecutively on a display unit (i.e. a display). The control unit 31 of FIG. 12, upon accepting the activation instruction, activates the select screen validating button determination unit 32. In step S401 of FIG. 15, the select screen validating button determination unit 32 determines whether to validate or to invalidate the “Start from the canceled screen” button on the select screen by the above processing.

The following step S402, the select screen is output and displayed on the display unit based on the configuration file of the select screen by the restart screen select screen output unit 33. When a determination is made to validate the “Start from the canceled screen” button in step S401, the “Start from the beginning” button, a “Continue” button, and a “Start from the canceled screen” button are validated and displayed on the select screen as shown in FIG. 13. When a determination is made to invalidate, the “Start from the beginning” button and the “Continue” button are validated and displayed on the select screen, and the “Start from the canceled screen” button is invalidated but still displayed on the select screen.

When the “Start from the beginning” button on the select screen is clicked by a user, step S302 of FIG. 11 is performed. In other words, by the second start (restart) screen determination unit 23, the screen ID of the first screen of the program is obtained as the restart screen ID and the screen output unit 15 is notified of the ID. Afterwards, the processing of steps S103, S104 and S105 of FIG. 6 is performed.

When the “Continue” button on the select screen is clicked by the user, the processing in steps S101-S105 of FIG. 6 is performed by the (first) start (restart) screen determination unit 34 etc.

When the “Start from the canceled screen” button on the select screen is clicked by the user, in step S403, the screen identifier kept in the screen identifier storage unit (storage region) 14 is obtained by the third start (restart) screen determination unit 36 and the screen output unit 15 is notified of the ID. Afterwards, the processing of steps S103, S104 and S105 of FIG. 6 is performed.

When the activation of the program by a user is not the activation on restart, the value of the screen identifier storage unit 14 is initialized. In such a case, the (first) start (restart) screen determination unit 34 or the third start (restart) screen determination unit 36 notifies the screen output unit 15 of the screen ID of the first screen of the activated program, and via the screen output unit 15, the first screen of the program is output on the display unit.

According to the configuration of FIG. 12, for example, when the instruction page (screen) runs to several pages and when canceled at a page in the middle, by selecting the “Continue” button, it is possible to restart from an appropriate point close to the canceled page (the first page of the instruction, for example), and it is also possible to restart from the canceled page by selecting “Start from the canceled page” button.

In a case where, the user has difficulty in understanding the instruction, even if restarted from the canceled page, the restart should start from the first page of the instruction, and in a case that the time period from the cancel to the restart is short or that the user has a good memory, the restart should be from the canceled page. Alternatively, in a case that a long time has elapsed since the cancel, by selecting the “Start from the beginning” button, the restart is from the first page of the program. In such a manner, the configuration of FIG. 12 provides further detailed support in accordance with the circumstances of the user.

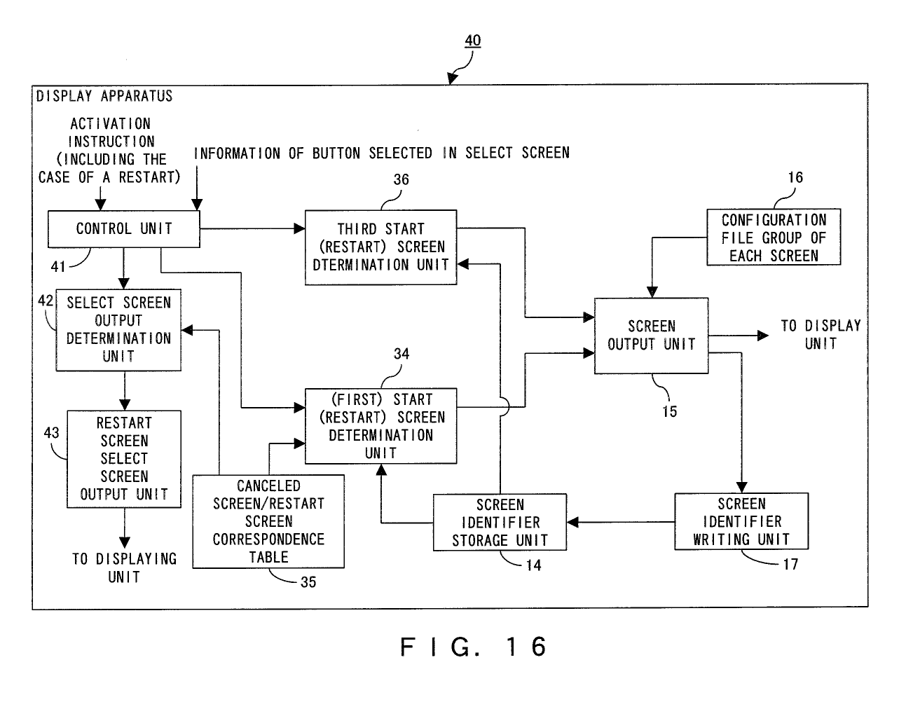

FIG. 16 is a block diagram describing a configuration of a variation (No. 2) of the display apparatus of the second embodiment of the present invention. FIG. 16 shows a functional block activated in association with each of a case that a control unit 41 accepts an activation instruction, and a case that the control unit 41 accepts information of a button selected in the select screen displayed on restart.

As shown in FIG. 16, a display apparatus 40 comprises a control unit 41 for controlling each unit, a screen identifier storage unit 14, which is able to store the ID (identifier) of the screen last displayed on the display unit (not shown in the drawing), a canceled screen/restart screen correspondence table 35 for maintaining the correspondence between the canceled screen ID and the restart screen ID, a (first) start (restart) screen determination unit 34 for obtaining a screen identifier stored in the screen identifier storage unit 14 and the restart screen ID corresponding to the obtained screen ID, employing the table with a correspondence between a canceled screen and a restart screen, and for notifying the screen output unit 15 of the obtained screen ID, a third start (restart) screen determination unit 36 for obtaining a screen identifier stored in the screen identifier storage unit 14 and for notifying the screen output unit 15 of the ID, a screen output unit 15 for selecting a configuration file corresponding to the notified screen ID from the configuration file group 16, for generating a screen based on the selected configuration file, and for outputting on the display unit, a screen identifier writing unit 17 for overwriting the output screen ID on the screen identifier storage unit 14, a restart screen select screen output unit 43 for outputting a screen for selecting the restart screen, and a select screen output determination unit 42 for determination of whether to activate the restart screen select screen output unit 43 or not.

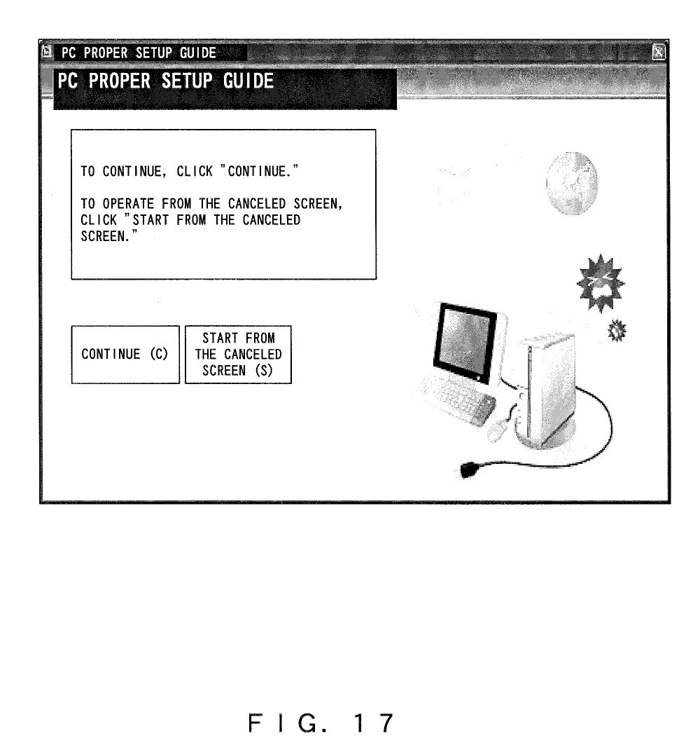

FIG. 17 is an example of the select screen output to the display unit by the restart screen select screen output unit of FIG. 16.

As shown in FIG. 17, on the select screen, a “Start from the canceled screen” button is provided as another option in addition to the “Continue” button. When the “Start from the canceled screen” button is not validated on the select screen, the select screen is not displayed. Whether to activate the select screen or not is determined by the select screen output determination unit 42.

For example, the select screen output determination unit 42 may validate the “Start from the canceled screen” button, that is, output the select screen on the display unit, when the restart screen, which is a result of the processing triggered by the click of the “Continue” button, does not correspond to the canceled screen. Alternatively, as shown in FIG. 14, by adding flag information (“0” or “1”) to the end of the restart screen ID of the canceled screen/restart screen correspondence table 35, and by referring to the flag information, whether to validate the “Start from the canceled screen” button or not, or whether to output the select screen to the display unit or not, may be determined.

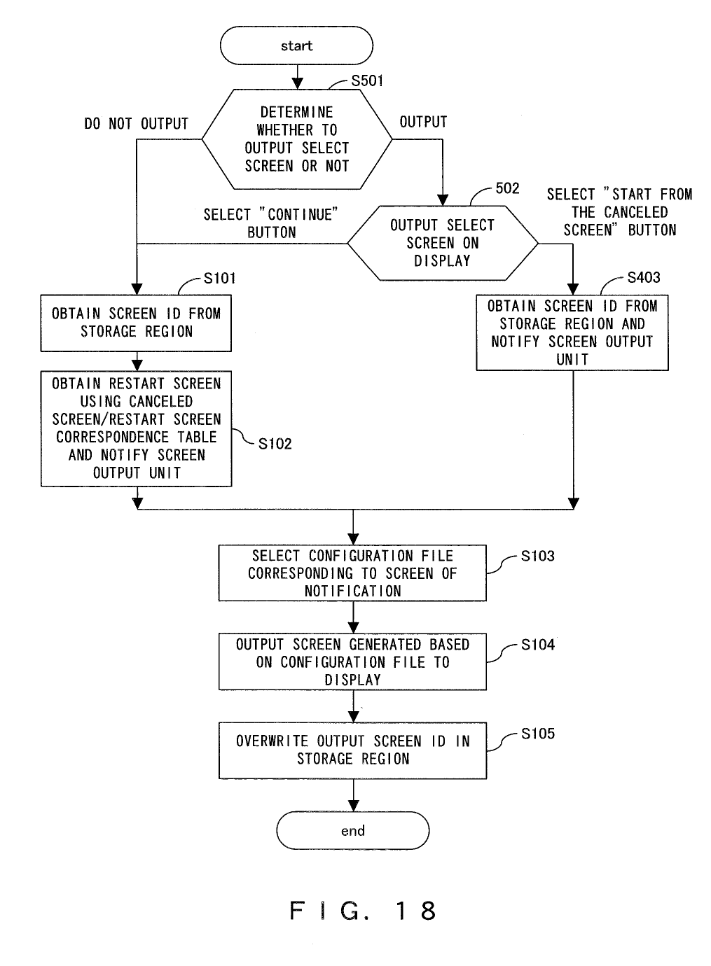

An operation of the display apparatus 40 of FIG. 16 is explained with reference to a flowchart of FIG. 18.

First, a program is activated by a user. The program is for outputting a plurality of screens consecutively on a display unit (i.e. a display). The control unit 41 of FIG. 16, upon accepting the activation instruction, activates the select screen output determination unit 42. In step S501 of FIG. 18, the select screen output determination unit 42 determines whether to output the select screen on the display unit by the above processing.

When it is determined that the select screen is not output, the processing of steps S101-S105 of FIG. 6 is performed by the (first) start (restart) screen determination unit 34 etc.

When it is determined that the select screen is output, in step S502, the select screen is output and displayed on the display unit (i.e. the display).

When the “Continue” button on the select screen is clicked by the user, the processing in steps S101-S105 of FIG. 6 is performed by the (first) start (restart) screen determination unit 34 etc.

When the “Start from the canceled screen” button on the select screen is clicked by the user, step S403 of FIG. 15 is performed. In other words, the screen identifier stored in the screen identifier storage unit (storage region) 14 is obtained by the third start (restart) screen determination unit 36 and the screen output unit 15 is notified of the ID. Afterwards, the processing of steps S103, S104 and S105 of FIG. 6 is performed.

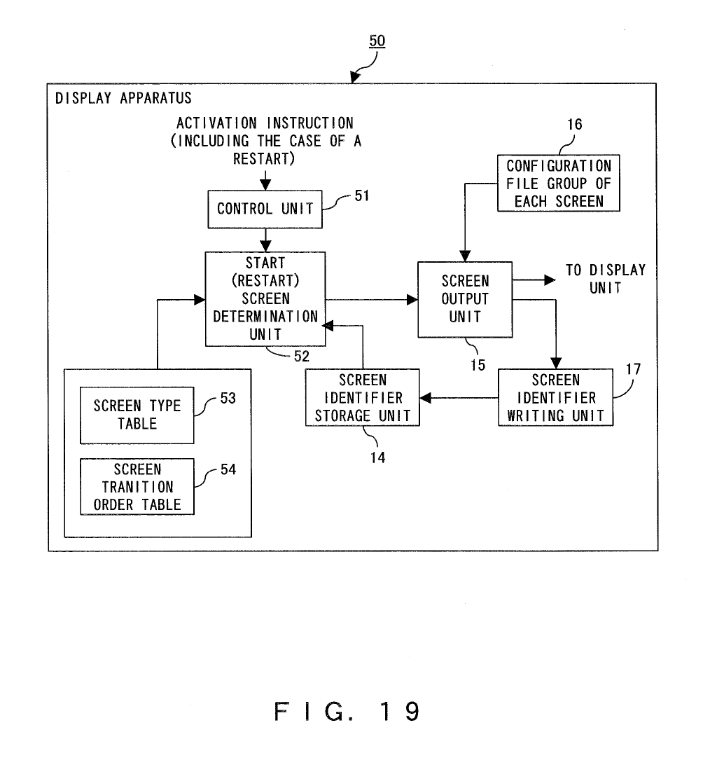

FIG. 19 is a block diagram describing a configuration of the display apparatus of the third embodiment of the present invention. FIG. 19 shows a functional block activated in association with a case where a control unit 51 accepts an activation instruction.

As shown in FIG. 19, a display apparatus 50 comprises a control unit 51 for controlling each unit, a screen identifier storage unit 14, which is able to store the ID (identifier) of the screen last displayed on the display unit (not shown in the drawing), a screen type table 53 for maintaining a correspondence between a screen ID and a screen type, a screen transition table 54 for defining screen transition order, a start (restart) screen determination unit 52 for obtaining a screen identifier stored in the screen identifier storage unit 14 and the restart screen ID corresponding to the obtained screen ID employing the screen type table 53 and the screen transition table 54 and for notifying the screen output unit 15 of the obtained screen ID, a screen output unit 15 for selecting a configuration file corresponding to the screen ID of the above notification from the configuration file group 16, for generating a screen based on the selected configuration file, and for outputting to the display unit, and a screen identifier writing unit 17 for overwriting the output screen ID in the screen identifier storage unit 14.

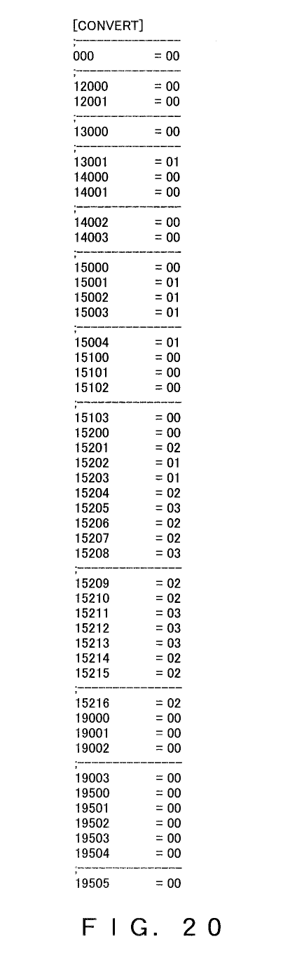

FIG. 20 is a diagram showing an example of the screen type table of FIG. 19.

As shown in FIG. 20, the screen type table is a table marinating a correspondence between a screen ID (left) and a screen type (right). In this example, screens are classified as the following types.

00: a screen for providing reading text on the screen to users

01: a screen for making a selection by a radio button etc.

02: a screen for inputting a variety of information in an input field

The table shown in FIG. 20, also, comprises information of the screen transition table for the screen IDs on the left is in a screen transition order (descending order).

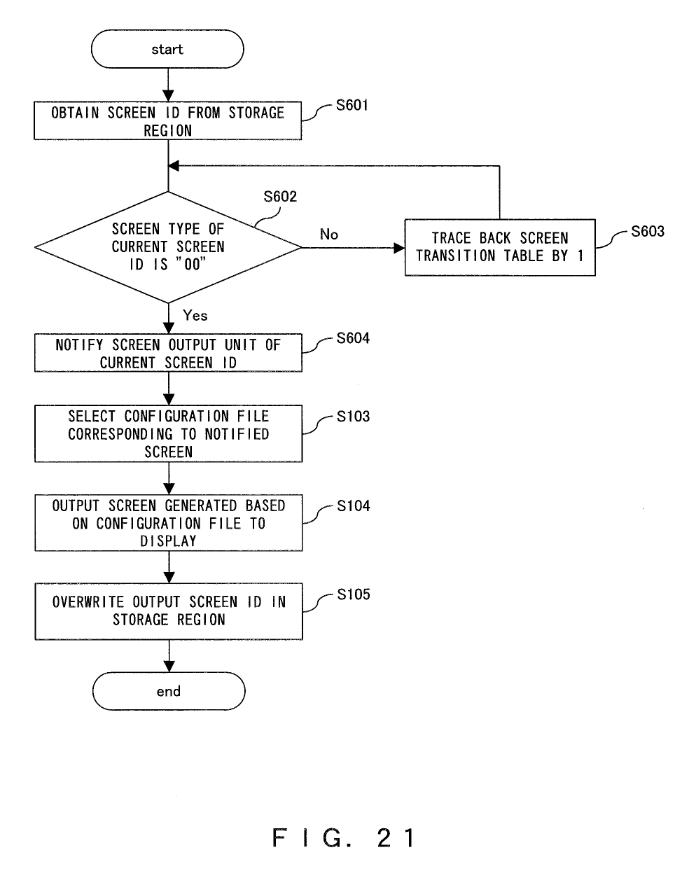

An operation of the display apparatus 50 of FIG. 19 is explained with reference to a flowchart of FIG. 21.

First, a program is activated by a user. The program is for outputting a plurality of screens consecutively on a display unit (i.e. a display). The control unit 51 of FIG. 19, upon accepting the activation instruction, activates the start (restart) screen determination unit 52. In step S601 of FIG. 21, the start (restart) screen determination unit 52 obtains the screen ID from the screen identifier storage unit (storage region) 14.

Next, in step S602, the start (restart) screen determination unit 52 refers to the screen type table comprising the information of the screen transition order of FIG. 20, for example, and it is determined whether or not the screen type corresponding to the current screen ID (the obtained screen ID at the first processing) is “00”.

When the current screen type is not “00”, in step S602, by tracing back the screen transition table by 1, the previous screen ID is set as the current screen ID, and the processing of step S602 is repeated.

When the current screen ID is “00”, in step S604, the screen output unit 15 is notified of the current screen ID. Afterwards, the processing of steps S103, S104 and S105 of FIG. 6 is performed.

In a configuration program, such as a printer setting or a browser setting, for example, an instruction of a user is independent from section to section (i.e. does not influence others instructions), and therefore, in FIG. 21, the processing returns only to the screen just before the user's instruction is given.

When the activation of the program by a user is not the activation on restart, the value of the screen identifier storage unit 14 is initialized. In such a case, the start (restart) screen determination unit 52 notifies the screen output unit 15 of the screen ID of the first screen of the activated program, and via the screen output unit 15, the first screen of the program is output to the display unit.

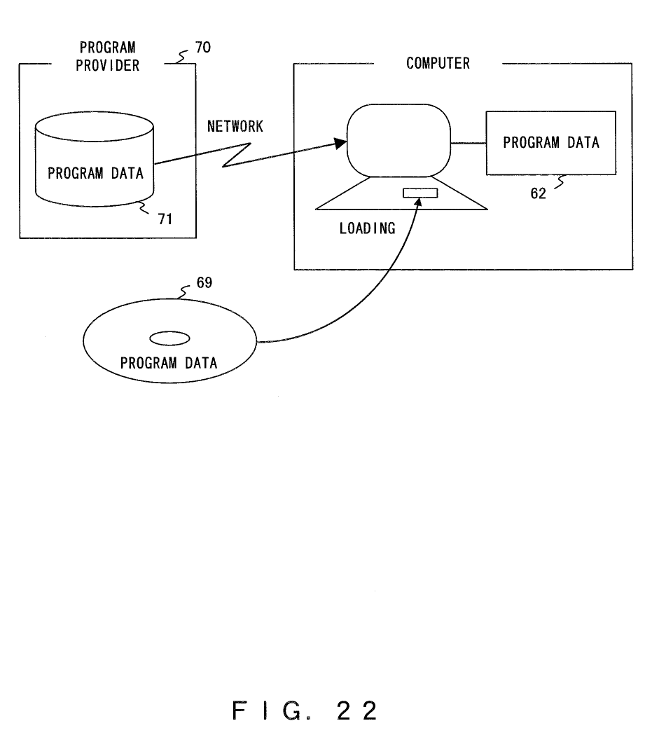

FIG. 22 is a diagram describing an example of storage medium.

Naturally, the data display processing of the present invention can be realized by a commonly used computer. In such a case, it is possible to perform the data display processing by loading a program for the processing of the present invention from a storage device 62 of a computer to memory of the computer, by loading the program for the processing of the present invention from portable storage medium 69 to the memory of the computer, or by loading the program for the processing of the present invention from a storage device 71 of a program provider 70 via a network to the memory of the computer.

What is claimed is:

1. A display apparatus for performing display processing of a plurality of screens consecutively on a display unit, comprising:
a canceled screen/restart screen storage unit for corresponding a canceled screen to a restart screen for each of the plurality of screens;
a restart screen determination unit making a determination of a screen in redisplaying in accordance with a screen displayed when a display is canceled among a plurality of the screens based on the canceled screen/restart screen storage unit; and
a screen output unit for outputting a screen determined by the restart screen determination unit on the display unit when redisplaying a plurality of the screens.

2. The display apparatus according to claim 1, further comprises a selecting operation unit for allowing a user to select a screen determined by the restart screen determination unit or a first screen of a plurality of the screens when redisplaying a plurality of the screens.

3. The display apparatus according to claim 2, wherein the selecting operation unit is activated when a restart screen determined by the restart screen determination unit does not correspond to a canceled screen.

4. The display apparatus according to claim 2, wherein the activation of the selecting operation unit is preset for each of a plurality of the screens.

5. The display apparatus according to claim 1, wherein the restart screen determination unit determines a screen to be redisplayed in accordance with a type of a screen displayed when canceled.

6. The display apparatus according to claim 1, wherein the restart screen determination unit determines a screen, to which a user can not input, as a redisplaying screen by tracing the consecution of a plurality of the screens from the canceled screen.

7. The display apparatus according to claim 1, wherein
a plurality of the screens comprises at least one chapter with at least one screen, and
the restart screen determination unit determines a first screen of the chapter to which a canceled screen belongs as a redisplaying screen.

8. A display method for performing display processing of a plurality of screens consecutively on a display unit, comprising:
a restart screen determination step for determination of a screen in redisplaying in accordance with a screen displayed when a display is canceled among a plurality of the screens based on correspondence of a canceled screen to a restart screen for each of a plurality of the screens stored in a canceled screen/restart screen storage unit; and
a screen output step for outputting a screen determined by the restart screen determination unit to the display unit when redisplaying a plurality of the screens.

9. The display method according to claim 8, further comprises a step to activate a selecting operation unit for allowing a user to select a screen determined in the restart screen determination step or a first screen of a plurality of the screens when redisplaying a plurality of the screens.

10. The display method according to claim 9, wherein the selecting operation unit is activated when a restart screen determined by the restart screen determination step does not correspond to a canceled screen.

11. The display method according to claim 9, wherein the activation of the selecting operation unit is preset for each of a plurality of the screens.

12. The display method according to claim 8, wherein in the restart screen determination step, a redisplaying screen is determined in accordance with a type of a screen displayed when canceled.

13. The display method according to claim 8, wherein in the restart screen determination step, a screen, to which a user can not input, is determined as a redisplaying screen by tracing the consecution of a plurality of the screens from the canceled screen.

14. The display method according to claim 8, wherein
a plurality of the screens comprises at least one chapter with at least one screen, and
the restart screen determination step determines a first screen of the chapter to which a canceled screen belongs as a redisplaying screen.

15. Storage medium for storing a display program causing a computer to perform display processing of a plurality of screens consecutively on a display unit of the computer, wherein the display program causes the computer to perform:
a restart screen determination step for determination of a redisplaying screen in accordance with a screen displayed when a display is canceled among a plurality of the screens based on a correspondence of a canceled screen to a restart screen for each of a plurality of the screens stored in a canceled screen/restart screen storage unit; and
a screen output step for outputting a screen determined by the restart screen determination unit on the display unit when redisplaying a plurality of the screens.

16. The storage medium according to claim 15, wherein the display program further comprises a step to activate a selecting operation unit for allowing a user to select a screen determined in the restart screen determination step or a first screen of a plurality of the screens when redisplaying a plurality of the screens.

17. The storage medium according to claim 16, wherein in the display program the selecting operation unit is activated when a restart screen determined by the restart screen determination step does not correspond to a canceled screen.

18. The storage medium according to claim 16, wherein in the display program the activation of the selecting operation unit is preset for each of a plurality of the screens.

19. The storage medium according to claim 15, wherein the display program, in the restart screen determination step, determines a screen to be redisplayed in accordance with a type of a screen displayed when canceled.

20. The storage medium according to claim 15, wherein the display program, in the restart screen determination step, determines a screen, to which a user can not input, as a redisplaying screen by tracing the consecution of a plurality of the screens from the canceled screen.

21. The storage medium according to claim 15, wherein a plurality of the screens comprises at least one chapter with at least one screen, and
the restart screen determination step in the display program determines a first screen of the chapter to which a canceled screen belongs as a redisplaying screen.
